(19) United States
(12) Patent Application Publication
(10) Pub. No.: US 2018/0350206 A1
(43) Pub. Date: Dec. 6, 2018

(54) SYSTEM AND METHOD FOR PROVIDING PORTABLE LIGHT

(71) Applicant: Patrick Ihm, Dodgeville, WI (US)

(72) Inventor: Patrick Ihm, Dodgeville, WI (US)

(21) Appl. No.: 16/000,191

(22) Filed: Jun. 5, 2018

Related U.S. Application Data
(60) Provisional application No. 62/515,489, filed on Jun. 5, 2017.

(51) Int. Cl. G08B 7/06; G08B 25/10

(52) U.S. Cl. CPC G08B 7/06; F21L 4/08; G08B 25/10

(57) ABSTRACT

A system for providing portable light; the system includes a charging base station having a communications transmitter and a portable light device configured to mechanically, electronically, and communicably couple with the charging base station. The portable light device includes a housing, a first light source, a second light source, at least one hook, at least one side mount, a communications receiver, an electronic alarm, and a rechargeable battery supply. The system further includes a mobile application that is useful for operating and establishing communications between the communications transmitter and the portable light device.

### CROSS-REFERENCE TO RELATED APPLICATION(S)

The present application is related to and claims priority to U.S. Provisional Patent Application No. 62/515,489 filed Jun. 5, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of power tools of existing art and more specifically relates to wireless tracking systems for tools.

### RELATED ART

Theft and misplacement of power tools at job sites and during transportation are significant problems for professional power tool users. Higher costing and higher quality power tools often are subject to a greater risk of thievery. In some instances, potential buyers choose lower costing and lower quality power tools to reduce the chances or impact of theft. Additionally, periodically checking inventory of such tools, for instance, to ensure all tools are returned at the end of a workday, can be a burdensome and cumbersome process. The burden is particularly significant for businesses responsible for maintaining a large corral of tools. A suitable solution is desired.

U.S. Pat. No. 9,467,862 to Jeffrey M. Zeiler, et al. relates to wireless tracking of power tools and related devices. The described wireless tracking of power tools and related devices includes a method and system for wirelessly tracking power tools and related devices to aid with inventory management and to help minimize, prevent, and recover misplaced or stolen tools throughout the job site. The tools and/or batteries include wireless transmitting capabilities (e.g., an ISM unit) to transmit data to a fob, puck repeater, and/or gateway over an ISM network. The gateway is operable to translate and output the ISM communications over a cellular network to a remote monitoring unit, such as a personal computer or smart phone. Additionally, the gateway is further operable to translate and output cellular communications from the remote monitoring unit to ISM communications over the ISM network. A wireless tethering system and method is also disclosed whereby an ISM battery places a power tool in a lock-out or limp mode after the ISM battery remains outside of ISM communications for a prolonged period of time.

### SUMMARY OF THE INVENTION

In view of the foregoing disadvantages inherent in the known power tool art, the present disclosure provides a novel system and method for providing portable light. The general purpose of the present disclosure, which will be described subsequently in greater detail, is to provide a portable hand-held cordless light having attachments, magnetic mounts, and a locator system that allows a user to easily find the light when lost or misplaced.

A system for providing portable light is disclosed herein. The system may include a charging base station having a communications transmitter and a portable light device configured to mechanically, electronically, and communicably couple with the charging base station. The portable light device may include a housing, a first light source, a second light source, at least one hook, at least one side mount, a communications receiver, an electronic alarm, and a rechargeable battery supply. The system may further include a mobile application that is useful for operating and establishing communications between the communications transmitter and the portable light device.

According to another embodiment, a method of using a portable light device is also disclosed herein. The method of using a portable light device may include providing a system including a charging base station and portable light device, aiming the portable light device, signaling the portable light device, producing an audible sound by the included electronic alarm, and locating the portable light device.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a system and method for providing portable light, constructed and operative according to the teachings of the present disclosure.

FIG. 1 is a perspective view of the system for providing portable light during an ‘in-use’ condition, according to an embodiment of the disclosure.

FIG. 2 is a side perspective view of the system for providing portable light of FIG. 1, according to an embodiment of the present disclosure.

FIGS. 3A and 3B are side views of the system for providing portable light of FIG. 1, according to an embodiment of the present disclosure.

FIGS. 4A and 4B are front and back views of the system for providing portable light of FIG. 1, according to an embodiment of the present disclosure.

FIG. 5 is a flow diagram illustrating a method of using the portable light device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to power tools and more particularly to a system and method for providing portable light as used to provide a portable hand-held cordless light having attachments, magnetic mounts, and a locator system that allows a user to easily find the light when lost or misplaced.

Generally, present invention provides a cordless, rechargeable task light with attachments for hanging and magnets for securing to surfaces. This present invention allows users to locate the light if misplaced, lost, or cordless light, that has dissipated the main batteries, to use a remote finder and GPS locating system. This further enables users to utilize their mobile phone or computer or a transmitter to locate the cordless rechargeable light or flashlight. As designed, it features fluorescent colorings to make the device easier to locate. The present invention appeals to mechanics, plumbers, electricians, and anyone else who commonly utilizes a flashlight or cordless rechargeable light for tasks.

The task light of this disclosure may include a remote finder, GPS/radar locating ability, and be compatible with a mobile or desktop device. The outer case may be made of plastic and surrounded by a rubber impact resistant coating. The coating is waterproof, oil and chemical resistant, and available in bright fluorescent colors, such as orange, green, etc. The light includes two hanging hooks, a wrist strap, a magnet on the base, and a couple on the back. LED lights are located on the end for a flashlight type scenario, and multiple lights on the front for larger tasks. The device includes rechargeable batteries and audible alert when the location button is pressed or if trying to locate with a mobile device, or computer. The button is located on a computer or wall transmitter. A GPS device is located within to assist users in locating the device with a mobile phone or computer. A backup battery may also be included. The exact specifications may vary.

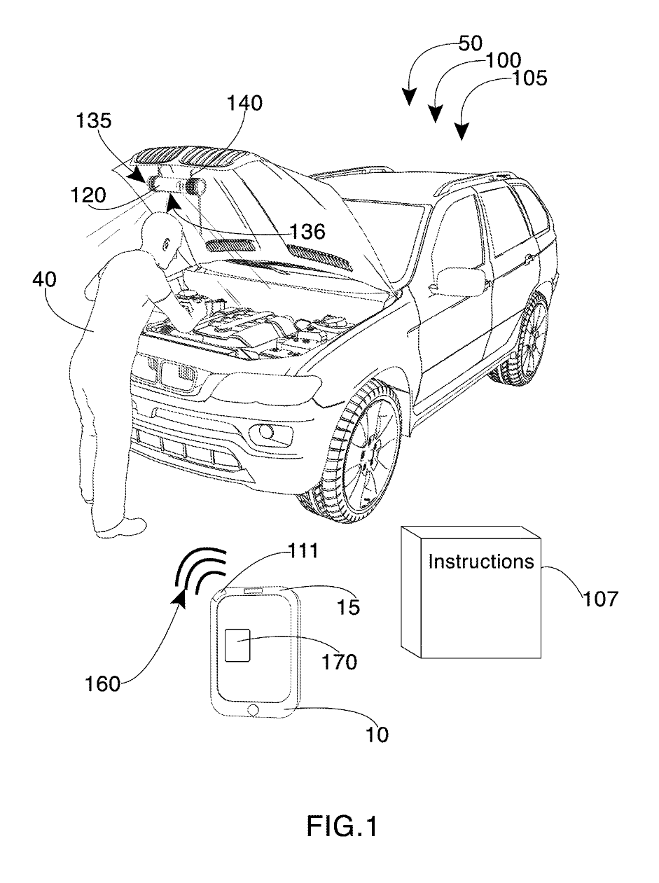

Referring now more specifically to the drawings by numerals of reference, there is shown in FIGS. 1-4, various views of a system 100 for providing portable light.

FIG. 1 shows a system 100 for providing portable light during an ‘in-use’ condition 50, according to an embodiment of the present disclosure. Here, the system 100 for providing portable light may be beneficial for use by a user 40 to provide a portable hand-held cordless light having attachments, magnetic mounts, and a locator system that allows a user to easily find the light when lost or misplaced. As illustrated, the system 100 for providing portable light may include a portable light device 120 including at least one hook 140, a first light source 135, and a second light source 136. The system 100 for providing portable light may also include a mobile application 170 installable on a mobile device 10 having at least one radio 15. The mobile application 170 may be configured to operate the at least one radio 15 of the mobile device 10 to send at least one signal 160 to the portable light device 120. The mobile device 10 may signal the portable light device by sending wireless transmissions through a communications transmitter 111.

According to one embodiment, the system 100 for providing portable light may be arranged as a kit 105. In particular, the system 100 for providing portable light may further include a set of instructions 107. The instructions 107 may detail functional relationships in relation to the structure of the system 100 for providing portable light such that the system 100 can be used, maintained, or the like, in a preferred manner.

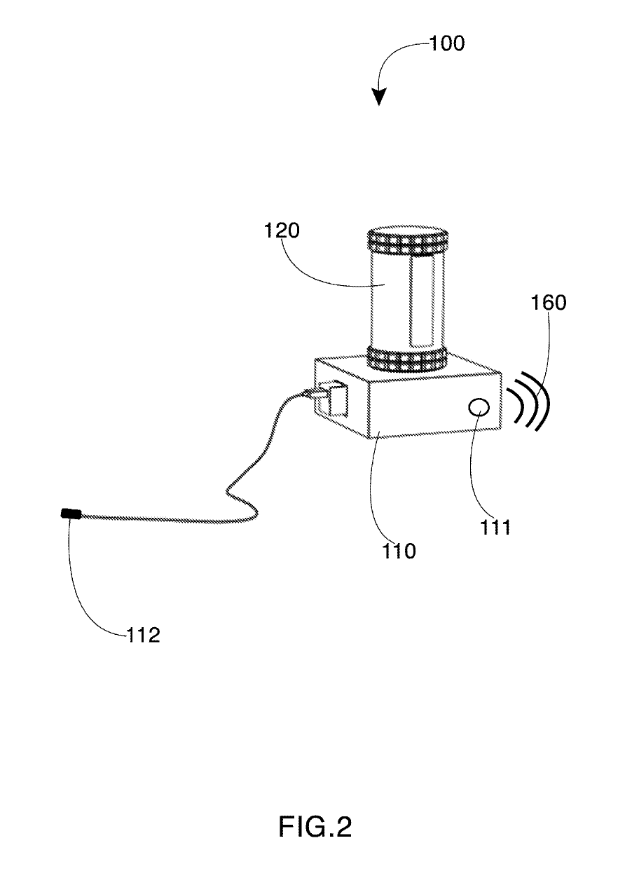

FIG. 2 shows the system 100 for providing portable light of FIG. 1, according to an embodiment of the present disclosure. As above, the system 100 may include a charging base station 110 having a communications transmitter 111 and a power cord 112 configured to provide external power to the charging base station 110. The system 100 may also feature a portable light device 120 configured to receive at least one signal 160 wirelessly transmitted by the communications transmitter 111 of the charging base station 110.

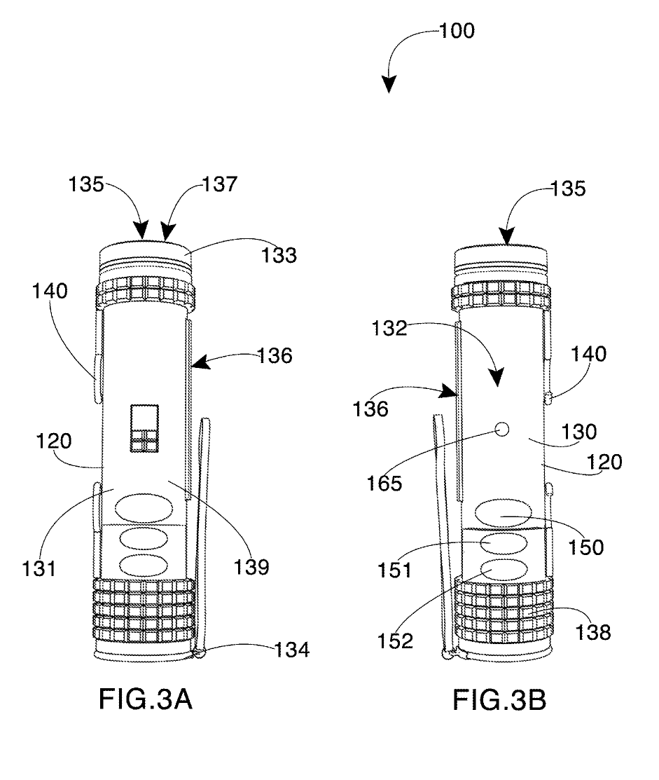

FIGS. 3A and 3B are side views of the system 100 for providing portable light of FIG. 1, according to an embodiment of the present disclosure. Here again, the system 100 may include a portable light device 120 featuring a rechargeable battery power supply 165. The portable light device 120 may also include a housing 130 having an outer surface 131, an inner volume 132, a light-end 133 and a grip-end 134 opposite the light-end 133. Further still, the device 120 may include a first light source 135 fixed to the housing 130, and positioned proximate the light-end 133 of the housing 130, along with a second light source 136 fixed to the housing 130, and positioned along the outer surface 131 between the light-end 133 and the grip-end 134. The portable light device 120. The first light source 135 and second light source 136 may each include a light emitting diode 137 (LED), respectively. In addition, the device 120 may include at least one hook 140 mechanically coupled to the outer surface 131. The housing 130 may be fluorescent 139 in color and also include rubber grip 138. Finally, the portable light device 120 may include a communications receiver 150 and an electronic alarm 151 fixed to the housing 130. The electronic alarm 151 may include a warning light 152 that is configured to blink.

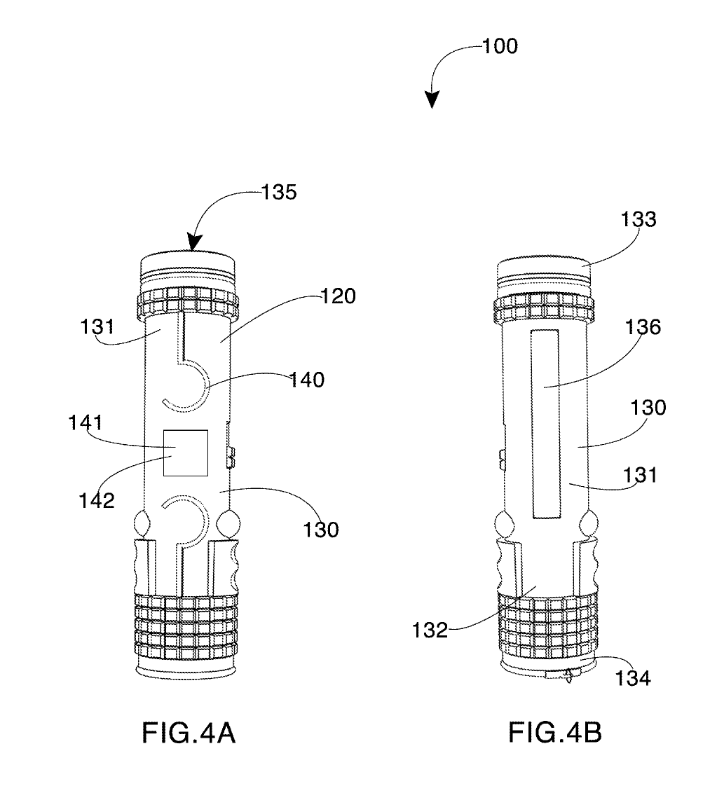

FIGS. 4A and 4B are front and back views of the system 100 for providing portable light of FIG. 1, according to an embodiment of the present disclosure. As above, the system 100 may include a portable light device 120 featuring a housing 130 having an outer surface 131, an inner volume 132, a light-end 133 and a grip-end 134 opposite the light-end 133. The portable light device 120 may also include a first light source 135 and a second light source 136 fixed to the housing 130. Further still, the portable light device 120 may include at least one hook 140 mechanically coupled to the outer surface 131. Finally, the portable light device 120 may also include at least one side mount 141 fixed to the housing 130. The at least one side mount 141 may feature a magnet 142 that has at least 5 pounds of pull force.

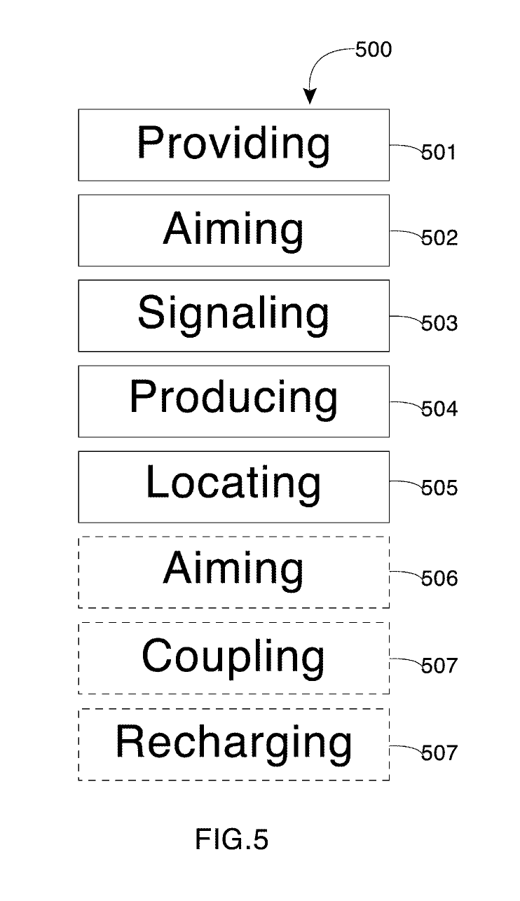

FIG. 5 is a flow diagram illustrating a method 500 of using a portable light device 120, according to an embodiment of the present disclosure. In particular, the method 500 of using a portable light device 120 may include one or more components or features of the system 100 for providing portable light as described above. As illustrated, the method 500 of using a portable light device 120 may include the steps of: step one 501, providing a system including a charging base station including a communications transmitter, a mobile application installable on a mobile device having at least one radio, the mobile application configured to operate the at least one radio of the mobile device, a portable light device configured to mechanically, electronically, and communicably couple with the charging base station, the portable light device including a housing having an outer surface, an inner volume, a light-end and a grip-end opposite the light end, a first light source fixed to the housing and positioned proximate the light-end of the housing, a second light source fixed to the housing, and positioned along the outer surface between the light-end and the grip-end, at least one hook mechanically coupled to the outer surface, the at least one hook configured to hang the portable light device from an object, at least one side mount fixed to the housing, and positioned on the outer surface between that light-end and the grip-end, the at least one side mount configured to magnetically couple with a ferromagnetic material, a communications receiver fixed to the housing, and positioned within the inner volume of the housing, the communications receiver configured to receive at least one signal wirelessly transmitted by the communications transmitter of the charging base station, and further configured to receive another at least one signal wirelessly transmitted by the at least one radio of the mobile device, an electronic alarm fixed to the housing, and configured to produce an audible sound in response to receiving the at least one signal wirelessly transmitted by the communications transmitter of the charging base station or the at least one signal wirelessly transmitted by the communications transmitter at least one radio of the mobile device, and a rechargeable battery power supply affixed to the housing, and positioned within the inner volume of the housing, the rechargeable battery power supply configured to power the portable light device, and further configured to electronically couple with and be charged by the charging base station; step two 502, aiming the portable light device to shine on a surface via the at least one hook; step three 503, signaling the portable light device via a transmission from the base station or the mobile device; step four 504, producing the audible sound by the electronic alarm, in response to the signaling the portable light device via a transmission from the base station or the mobile device; and step five 505, locating the portable light device via the producing the audible sound by the electronic alarm.

It should be noted that step six 506, aiming the portable light device to shine on the surface via the at least one side mount; step seven 507, mechanically and electronically coupling the portable light device with the charging base station; and step eight 508, recharging the rechargeable battery power supply of the portable light device via the charging base station, are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for system 100 for providing portable light, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for providing portable light, the system comprising:
a charging base station including a communications transmitter;
a portable light device configured to mechanically, electronically, and communicably couple with the charging base station, the portable light device including
a housing having an outer surface, an inner volume, a light-end and a grip-end opposite the light end,
a first light source fixed to the housing, and positioned proximate the light-end of the housing,
a second light source fixed to the housing, and positioned along the outer surface between the light-end and the grip-end,
at least one hook mechanically coupled to the outer surface, the at least one hook configured to hang the portable light device from an object,
at least one side mount fixed to the housing, and positioned on the outer surface between that light-end and the grip-end, the at least one side mount configured to magnetically couple with a ferromagnetic material,
a communications receiver fixed to the housing, and positioned within the inner volume of the housing, the communications receiver configured to receive at least one signal wirelessly transmitted by the communications transmitter of the charging base station,
an electronic alarm fixed to the housing, and configured to produce an audible sound in response to receiving the at least one signal wirelessly transmitted by the communications transmitter of the charging base station, and
a rechargeable battery power supply affixed to the housing, and positioned within the inner volume of the housing, the rechargeable battery power supply configured to electronically couple with and be charged by the charging base station.

2. The system of claim 1, further comprising a mobile application installable on a mobile device having at least one radio, the mobile application configured to operate the at least one radio of the mobile device to signal the communications receiver of the portable light device; and
wherein the communications receiver is further configured to receive another at least one signal wirelessly transmitted by the communications transmitter at least one radio of the mobile device.

3. The system of claim 1, wherein the at least one side mount includes a magnet.

4. The system of claim 3, wherein the magnet has at least 5 pounds of pull force.

5. The system of claim 1, wherein the electronic alarm is further configured to sound in response to the power supply reaching a low power state.

6. The system of claim 5, wherein the electronic alarm includes a warning light.

7. The system of claim 6, wherein the warning light is configured to blink.

8. The system of claim 5, wherein the electronic alarm is further configured to beep when selectively prompted by the communications transmitter of the charging base station.

9. The system of claim 1, wherein the communications transmitter of the charging base station has a transmission range of at least 45 feet.

10. The system of claim 1, wherein the at least one hook of the portable light device is configured to deploy outward from the housing.

11. The system of claim 1, wherein the communications receiver is further configured to receive a signal from the mobile application.

12. The system of claim 1, wherein the first light source and second light source each include a light emitting diode (LED), respectively.

13. The system of claim 1, wherein the first light source is arranged as a directed spotlight.

14. The system of claim 1, wherein the charging base station further includes a power cord configure to provide external power to the charging base station.

15. The system of claim 1, wherein the housing includes rubber grip.

16. The system of claim 1, wherein the housing is fluorescent in color.

17. A system for providing portable light comprising:
a charging base station including a communications transmitter;
a portable light device configured to mechanically, electronically, and communicably couple with the charging base station, the portable light device including
a housing having an outer surface, an inner volume, a light-end and a grip-end opposite the light end,
a first light source fixed to the housing, and positioned proximate the light-end of the housing,
a second light source fixed to the housing, and positioned along the outer surface between the light-end and the grip-end,
at least one hook mechanically coupled to the outer surface, the at least one hook configured to hang the portable light device from an object,
at least one side mount fixed to the housing, and positioned on the outer surface between that light-end and the grip-end, the at least one side mount configured to magnetically couple with a ferromagnetic material,
a communications receiver fixed to the housing, and positioned within the inner volume of the housing, the communications receiver configured to receive at least one signal wirelessly transmitted by the communications transmitter of the charging base station,
an electronic alarm fixed to the housing, and configured to produce an audible sound in response to receiving the at least one signal wirelessly transmitted by the communications transmitter of the charging base station, and
a rechargeable battery power supply affixed to the housing, and positioned within the inner volume of the housing, the rechargeable battery power supply configured to electronically couple with and be charged by the charging base station;
further comprising a mobile application installable on a mobile device having at least one radio, the mobile application configured to operate the at least one radio of the mobile device to signal the communications receiver of the portable light device; and
wherein the communications receiver is further configured to receive another at least one signal wirelessly transmitted by the communications transmitter at least one radio of the mobile device;
wherein the at least one side mount includes a magnet;
wherein the magnet has at least 5 pounds of pull force;
wherein the electronic alarm is further configured to sound in response to the power supply reaching a low power state;
wherein the electronic alarm includes a warning light;
wherein the warning light is configured to blink;
wherein the electronic alarm is further configured to beep when selectively prompted by the communications transmitter of the charging base station;
wherein the communications transmitter of the charging base station has a transmission range of at least 45 feet;
wherein the at least one hook of the portable light device is configured to deploy outward from the housing;
wherein the communications receiver is further configured to receive a signal from the mobile application;
wherein the first light source and second light source each include a light emitting diode (LED), respectively;
wherein the first light source is arranged as a directed spotlight;
wherein the charging base station further includes a power cord configured to provide external power to the charging base station;
wherein the housing includes rubber grip; and
wherein the housing is fluorescent in color.

18. The system of claim 17, further comprising set of instructions; and
wherein the device is arranged as a kit.

19. A method of using a portable light device, the method comprising the steps of:
providing a system including
a charging base station including a communications transmitter,
a mobile application installable on a mobile device having at least one radio, the mobile application configured to operate the at least one radio of the mobile device,
a portable light device configured to mechanically, electronically, and communicably couple with the charging base station, the portable light device including
a housing having an outer surface, an inner volume, a light-end and a grip-end opposite the light end,
a first light source fixed to the housing, and positioned proximate the light-end of the housing,
a second light source fixed to the housing, and positioned along the outer surface between the light-end and the grip-end,
at least one hook mechanically coupled to the outer surface, the at least one hook configured to hang the portable light device from an object,
at least one side mount fixed to the housing, and positioned on the outer surface between that light-end and the grip-end, the at least one side mount configured to magnetically couple with a ferromagnetic material,
a communications receiver fixed to the housing, and positioned within the inner volume of the housing, the communications receiver configured to receive at least one signal wirelessly transmitted by the communications transmitter of the charging base station, and further configured to receive another at least one signal wirelessly transmitted by the at least one radio of the mobile device,
an electronic alarm fixed to the housing, and configured to produce an audible sound in response to receiving the at least one signal wirelessly transmitted by the communications transmitter of the charging base station or the at least one signal wirelessly transmitted by the communications transmitter at least one radio of the mobile device, and
a rechargeable battery power supply affixed to the housing, and positioned within the inner volume of the housing, the rechargeable battery power supply configured to power the portable light device, and further configured to electronically couple with and be charged by the charging base station;
aiming the portable light device to shine on a surface via the at least one hook;
signaling the portable light device via a transmission from the base station or the mobile device;
producing the audible sound by the electronic alarm, in response to the signaling the portable light device via a transmission from the base station or the mobile device; and
locating the portable light device via the producing the audible sound by the electronic alarm.

20. The method of claim 19, further comprising the steps of:
aiming the portable light device to shine on the surface via the at least one side mount;
mechanically and electronically coupling the portable light device with the charging base station; and
recharging rechargeable battery power supply of the portable light device via the charging base station.
